(19) United States
(12) Patent Application Publication
(10) Pub. No.: US 2009/0286642 A1
(43) Pub. Date: Nov. 19, 2009

(54) CHAIN

(75) Inventor: Yoshiaki Takagishi, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO., Osaka (JP)

(21) Appl. No.: 12/409,737

(22) Filed: Mar. 24, 2009

(30) Foreign Application Priority Data
May 16, 2008 (JP) 2008-129558

(51) Int. Cl. F16G 13/07

(52) U.S. Cl. 474/231

(57) ABSTRACT

The outer link plates of a roller chain or rollerless bushing chain have one or more curved grooves formed by pressing, on their inner faces. The grooves connecting one of two pin holes formed in each plate to the other pin hole.

### CROSS-REFERENCE TO RELATED APPLICATION

This application claims priority on the basis of Japanese patent application 2008-129558, filed May 16, 2008. The disclosure of Japanese application 2008-129558 is hereby incorporated by reference.

### FIELD OF THE INVENTION

This invention relates to a chain for use in a power transmission, a conveying mechanism, or the like in such applications as automobile engines and industrial machinery. More specifically, it relates to a roller chain, or a rollerless bushing chain, in which alternating inner and outer links are connected by cooperating bushings and pins.

### BACKGROUND OF THE INVENTION

Roller chains and rollerless bushing chains are well known and widely used in a variety of applications. The typical chain is made up of alternating inner and outer links. Each inner link comprises a pair of inner link plates, and a pair of cylindrical bushings press-fit into bushing holes formed in the inner link plates and connecting the inner link plates in opposed, spaced, relationship. Each outer link comprises a pair of outer link plates. Each outer link plate has a pair of connecting pins press-fit into pin holes formed in the outer link plates and connecting the outer link plates in opposed, spaced, relationship. The inner links are disposed in alternating, overlapping relationship with the outer links, and each pin of each outer link extends rotatably through a bushing of an adjacent inner link, so that the inner and outer links are connected to form an elongated, articulating transmission medium, which is ordinarily formed as an endless loop for transmission of power from a driving sprocket to one or more driven sprockets.

It is also known to provide for introduction of lubricating oil into a clearance between a bushing and the connecting pin which extends through the bushing so that the chain can bend smoothly. It is also known to provide a groove in the outer link plate for more effectively introducing lubricating oil into the clearance between the bushing and the connecting pin.

FIGS. 9 and 10 show a typical outer link plate 521 of the known chain having a grooved outer link plate. The groove 524 is connected to each hole of a pair of front and rear pin holes 523 into which connecting pins of the chain are press-fit. The groove is formed on one surface of the plate 521 and extends along a straight line connecting the centers C of the two pin holes 523. The groove improves the introduction of lubricating oil into the clearance between a bushing and the connecting pin extending through it. An example of such a chain structure is described in Japanese Laid-open Patent Publication No. 2003-294089.

The straight grooved portion 524 in the outer link plate 521 of this known chain is the part that has the lowest rigidity. Therefore, when bending stress is applied to the outer link plate 521, deformation such as shown in FIG. 11 is liable to occur. Furthermore, when a working process such as pressing or the like is adopted, it can affect the residual stress in the plate. Consequently, in the formation of the conventional grooved plate, some deformation can occur in the process of forming the plate, and additional deformation can occur when the plate is in use.

When the outer link plate 521 becomes deformed, its outer edges can come into contact with an inner link plate 511, as shown in FIG. 12. Contact between the outer edges of plate 521 and the inner link plate 511 can result in frictional resistance which prevents smooth bending of the chain and generates noise. In addition, wear resulting from friction at the locations at which the edges of the deformed outer link plate contacts the inner link plates produces powder that promotes wear at other locations such as at the interface between the bushing 512 and the connecting pin 522, and at the interface between the bushing 512 and the roller 514.

This invention addresses the above-described problems, and it is an object of the invention to provide a chain in which sufficient lubricating oil is introduced into the clearances between a bushings and the connecting pins, while deformation of the outer link plate is prevented, so that the chain can bend smoothly during operation as a power transmitting medium, without generating large amounts of noise and without generating friction and excessive wear.

### SUMMARY OF THE INVENTION

The chain according to the invention comprises inner and outer links. Each inner link comprises a pair of inner link plates, and a pair of cylindrical bushings press-fit into bushing holes formed in the inner link plates and connecting the inner link plates in opposed, spaced, relationship. Each outer link comprises a pair of outer link plates. Each outer link plate has a pair of connecting pins press-fit into pin holes formed in the outer link plates and connecting the outer link plates in opposed, spaced, relationship. The inner links are disposed in alternating, overlapping relationship with the outer links, and each pin of each outer link extends rotatably through a bushing of an adjacent inner link, so that the inner and outer links are connected to form an elongated, articulating transmission medium. Each outer link plate has an elongated, curved, groove formed in one of its faces. The groove connects one of the pin holes formed therein to the other pin hole formed therein.

The curved grooves allow sufficient lubricating to be introduced into the clearance between the bushings and the connecting pins of the chain, while dispersing bending forces associated with the groove in different directions along the curve of the groove. As a result, deformation of the outer link plates can be prevented, the chain can flex smoothly, noises and vibrations are reduced, and friction and wear are also reduced.

The shape of the groove is preferably in the form of an arc, and the arcuate shape of the groove more effectively disperses the bending forces and prevents deformation of the outer link plate.

The groove is also preferably formed by pressing the link plate. Consequently, the groove can be easily and more accurately formed, ensuring that sufficient lubricating oil can be introduced through the groove into the clearance between the bushing and the connecting pin extending through the bushing.

In an alternative embodiment, each outer link plate has plural elongated, curved, grooves formed in one of its faces, each groove connecting one the pin holes formed therein to the other pin hole formed therein. When a plurality of grooves is provided, lubricating oil can be more efficiently introduced into the clearances between the bushings and the connecting pins. Furthermore, since there are plural grooves, the grooves can be shallower than a single groove, the bending forces can be more effectively dispersed, and deformation of the outer link plates can be prevented.

In a preferred embodiment, each of the pin holes in each outer plate is circular and has an inner semi-circular side closest to the other pin hole in the same plate, and the groove in each outer plate extends from the inner semi-circular side of one of the pin holes therein to the inner semi-circular side of the other pin hole. Locating the grooves on the inner semi-circular sides of the pin holes avoids reduction of the thickness of the end portions of the outer link plates, which are the portions to which the most stress is most applied when tension is applied to the chain. Thus, deformation of the chain due to tension, and breakage of the outer link plates can be prevented.

### BRIEF DESCRIPTION OF THE DRAWINGS

FIG. 1 is an exploded perspective view of a part of a chain, in accordance with the invention;

FIG. 2 is a cross-sectional view of the chain;

FIG. 3 is an elevational view showing the inside face of an outer link plate of a chain according to a first embodiment of the invention;

FIG. 4 is a cross-sectional view, taken on plane 4-4 in FIG. 3;

FIG. 5 is a cross-sectional view of a chain incorporating the outer link plate of FIG. 3;

FIG. 6 is an elevational view showing the inside face of an outer link plate of a chain according to a second embodiment of the invention;

FIG. 7 is a cross-sectional view, taken on plane 7-7 in FIG. 6;

FIG. 8 is a cross-sectional view of a chain incorporating the outer link plate of FIG. 6;

FIG. 9 is an elevational view showing the inside face of an outer link plate of a conventional chain;

FIG. 10 is a cross-sectional view of the outer link plate of FIG. 9;

FIG. 11 is a cross-sectional view showing the outer link plate of FIG. 9 in a deformed condition; and

FIG. 12 is a cross-sectional view of a chain incorporating the deformed outer link plate of FIG. 11.

### DETAILED DESCRIPTION OF THE PREFERRED EMBODIMENTS

The chain of the invention is a roller chain, or rollerless bushing chain, in which the outer link plates have elongated, curved, grooves connecting their front and rear pin holes. The grooves provide for more effective flow of lubricating oil into the clearances between the bushings of the chain and the connecting pins so that the chain can flex smoothly with reduced noise and vibration and reduced friction and wear. The curvature of the grooves prevents deformation of the outer link plate, and therefore also contributes to reduction in vibration, noise, friction and wear.

The chain of the invention can be provided in any of a wide variety of embodiments, and can be used in various mechanisms, such as engine valve timing systems, drives for auxiliary engine components such as oil pumps or the like, and in conveyors and other machines.

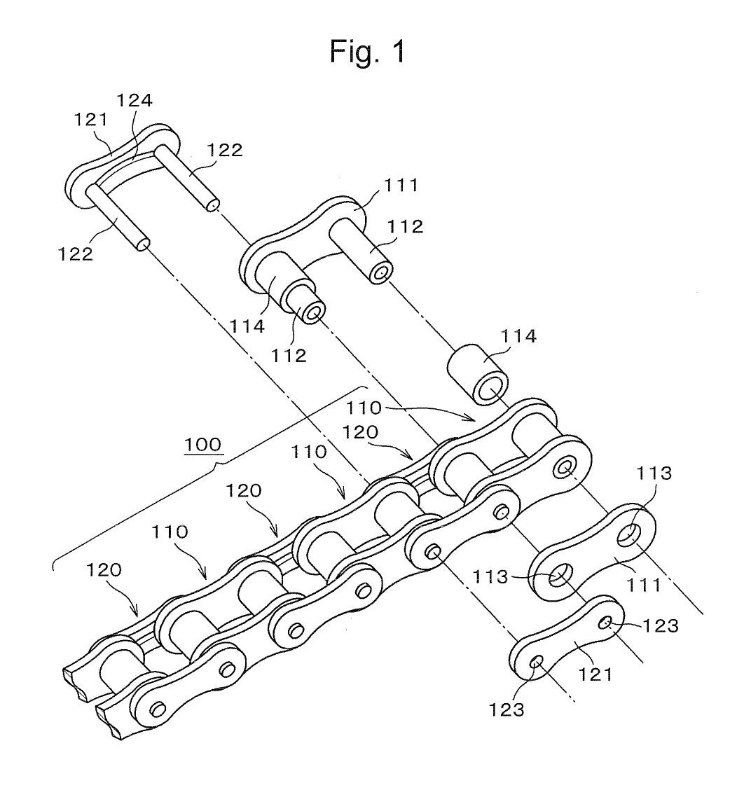

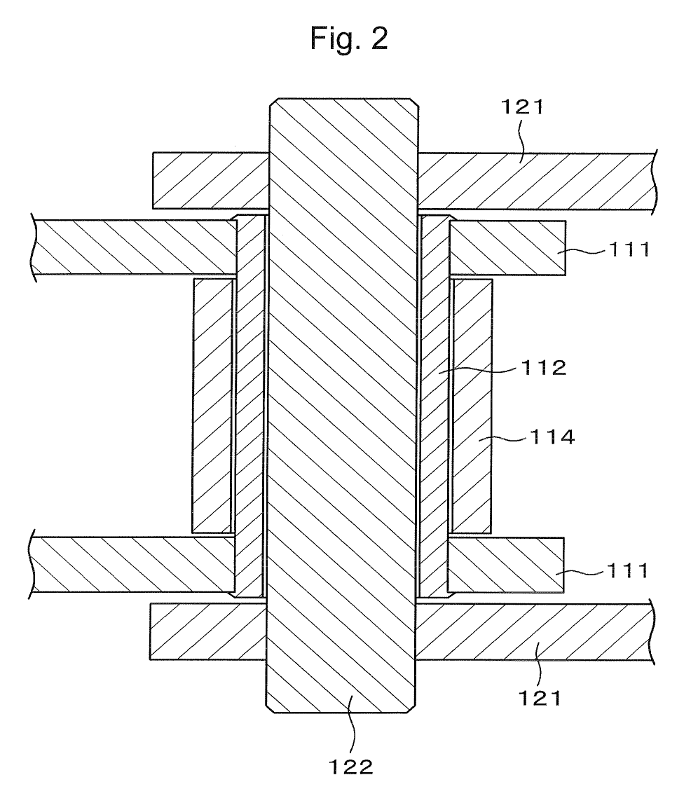

As shown in FIGS. 1 and 2, the chain 100, is composed of inner links 110 and outer links 120 arranged alternately along the length of the chain. Each inner link 110 is composed of a pair of right and left inner link plates 111, each having front and rear holes 113 in which cylindrical bushings 112 are press-fit. In the case of a roller chain, rollers 114 are provided, and are rotatable on the bushings 112.

Each outer link 120 is composed of a pair of right and left outer link plates 121, each having front and rear pin holes 123 in which connecting pins 122 are press-fit.

Each of the two connecting pins of an outer link 121 extends rotatably through a bushing of one of the two adjacent inner links, thereby connecting the inner and outer links to one another in an alternating arrangement, forming the chain 120.

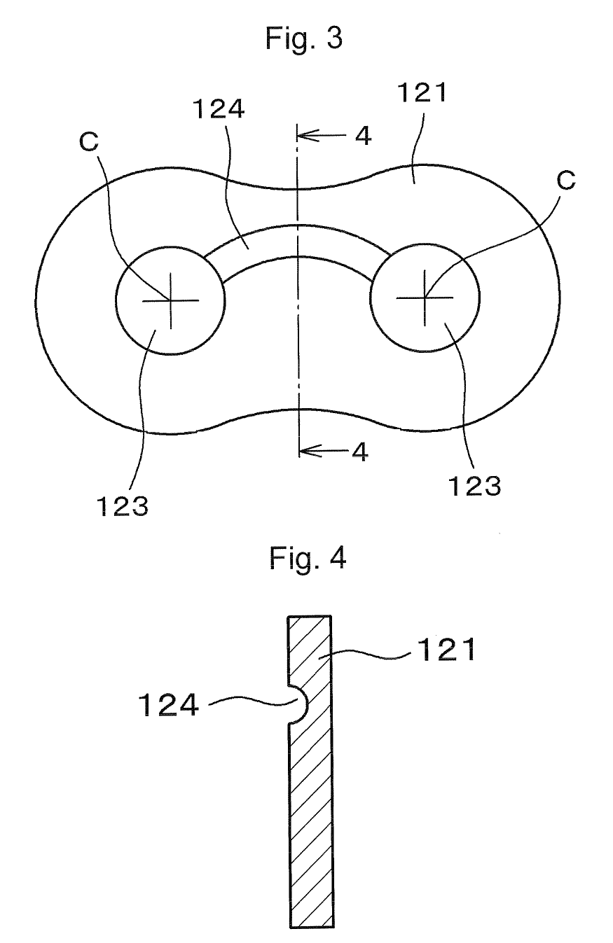

FIGS. 3 and 4 show an outer link plate 121 according to a first embodiment of the invention. A groove 124, formed on an inwardly facing side of plate 121, is connected to the front and rear pin holes 123, and extends in an arc so that its central region is spaced from an imaginary line connecting the centers points C of the pin holes 123. The groove is preferably formed by pressing the inwardly facing side of plate 121.

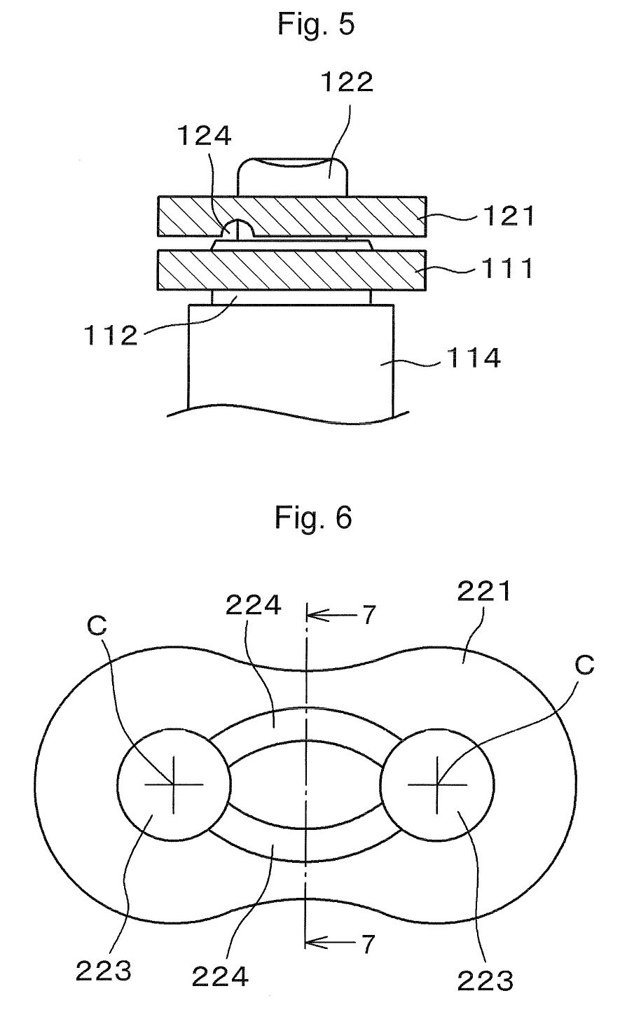

As shown in FIG. 5, the chain is assembled so that the groove 124 is on the inwardly facing side of the outer link plate 121, facing the overlapping inner link plates 111. A small clearance exists between outer link plate and its overlapping inner link plates 111. In the operation of the chain, lubricating oil is introduced through the groove to the clearances between its connecting pins 122 and the bushings 112 of the adjacent inner links.

When a force, such as a bending force or a torsional force, is applied to the outer link plate 121, the grooved portion of the plate, which is less rigid than the rest of the plate, is most liable to become deformed. However, since the groove 124 extends in an arc, the bending forces are dispersed and deformation of the plate 121 is prevented.

Furthermore, since the groove 124 is connected to the front and rear pin holes 123 on the semicircular sides thereof opposite each other, i.e. to the inside edges of the pin holes relative from the respective pin hole centers C, there is no reduction in the thickness of the end portions of the plates on the outer sides of the pin holes 123, where maximum stress occurs when tension is applied to the chain. Thus, deformation and breakage of the outer link plate 121 can be prevented.

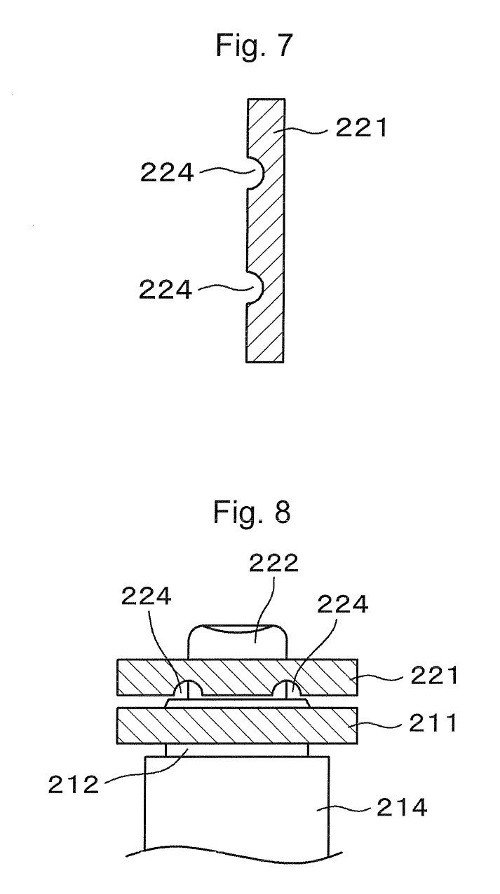

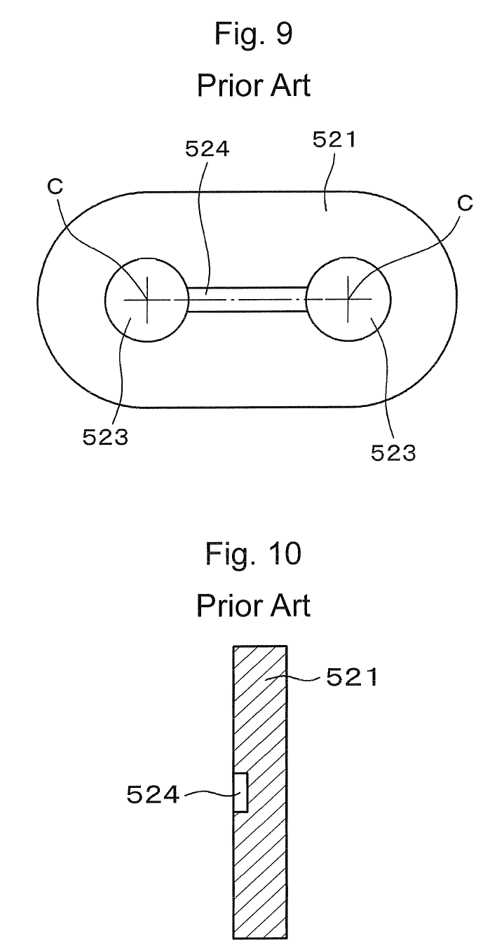

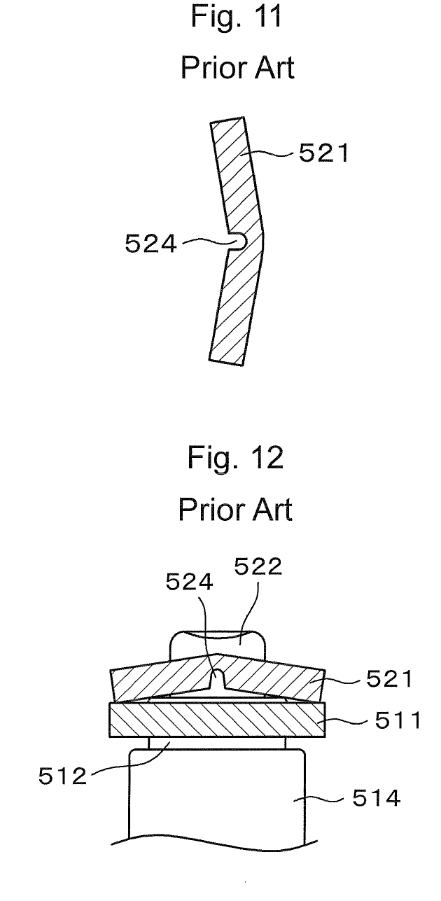

In another embodiment of the invention, shown in FIGS. 6 and 7, an outer link plate 221 is formed with two grooves 224 connecting its front and rear pin holes 223 and extends in arcs symmetrical with respect to an imaginary straight line connecting the centers C of the pin holes 223. As in the first embodiment, the grooves are preferably formed by pressing.

As shown in FIG. 8, the chain is assembled so that the grooves 224 are on the inwardly facing side of the outer link plate 221, facing the overlapping inner link plates 211. A small clearance exists between outer link plate and its overlapping inner link plates 211. In the operation of the chain, lubricating oil is introduced through the two grooves to the clearances between its connecting pins 222 and the bushings 212 of the adjacent inner links.

When a force, such as a bending force or a torsional force, is applied to the outer link plate 221, the grooved portions of the plate, which are less rigid than the rest of the plate, are most liable to become deformed. However, since each of the grooves 224 extends in an arc, the bending forces are dispersed, and deformation of the outer link plate 221 is prevented.

Since, as shown in FIG. 6, the grooves 224 are connected to the front and rear pin holes 223 on the semicircular sides thereof opposite each other, i.e. to the inside edges of the pin holes relative from the respective pin hole centers C, there is no reduction in the thickness of the end portions of the plates on the outer sides of the pin holes 223, where maximum stress occurs when tension is applied to the chain. Thus, deformation and breakage of the outer link plates 221 can be prevented.

Furthermore, since two grooves are provided in the second embodiment, they can be shallower than a single groove, and still conduct sufficient lubricating oil to the clearances between the bushings and the connecting pins. Furthermore, if the grooves 224 are symmetrical about an imaginary straight line connecting the centers of the pin holes, formation of the groove 224 is easy, and the outer link plate 221 can be used without concern for whether or not they are upside-down. Consequently, assembly of the chain is simplified.

According to the invention, since the outer link plates have elongated, curved, grooves connected to their front and rear pin holes, sufficient lubricating oil can be introduced into the clearances between the bushings and the connecting pins, and, at the same time, bending forces are dispersed so that deformation of the outer link plates can be prevented, the chain flexes smoothly, noise and vibration levels are low, and friction and wear are also reduced.

While the grooves in the outer link plates are preferably in the form of arcs, other groove shapes can be adopted. For example, the grooves can be in the form of parallel arcs. Furthermore, more than two grooves can be provided. As the number of grooves is increased, the depth of each groove can be reduced without reducing the supply of lubricating oil to the clearances between the bushings and the connecting pins.

I claim:

1. A chain comprising inner and outer links, each inner link comprising a pair of inner link plates, and a pair of cylindrical bushings press-fit into bushing holes formed in the said inner link plates and connecting said inner link plates in opposed, spaced, relationship, each outer link comprising a pair of outer link plates, each outer link plate having an inner face and an outer face, and a pair of connecting pins press-fit into pin holes formed in said outer link plates and connecting said outer link plates in opposed, spaced, relationship, the inner links being disposed in alternating, overlapping relationship with said outer links, and each pin of each outer link extending rotatably through a bushing of an adjacent inner link, whereby said inner and outer links are connected to form an elongated, articulating transmission medium, wherein each said outer link plate has an elongated, curved, groove formed in one of its faces, said groove connecting one of the pin holes formed therein to the other pin hole formed therein.

2. A chain according to claim 1, in which the shape of said groove is in the form of an arc.

3. A chain according to claim 1, in which said groove is formed by pressing the link plate in which it is formed.

4. A chain according to claim 1, in which the shape of said groove is in the form of an arc, and in which said groove is formed by pressing the link plate in which it is formed.

5. A chain according claim 1 in which each said outer link plate has plural elongated, curved, grooves formed in one of its faces, each of said grooves connecting one the pin holes formed therein to the other pin hole formed therein.

6. A chain according claim 1 in which each said outer link plate has plural elongated, curved, grooves formed in one of its faces, each of said grooves connecting one the pin holes formed therein to the other pin hole formed therein, and in which the shape of each said groove is in the form of an arc.

7. A chain according claim 1, in which each said outer link plate has plural elongated, curved, grooves formed in one of its faces, each of said grooves connecting one the pin holes formed therein to the other pin hole formed therein, and in which said grooves are formed by pressing the link plate in which they are formed.

8. A chain according claim 1, in which each said outer link plate has plural elongated, curved, grooves formed in one of its faces, each of said grooves connecting one the pin holes formed therein to the other pin hole formed therein, in which the shape of each of said grooves is in the form of an arc, and in which said grooves are formed by pressing the link plate in which they are formed.

9. A chain according claim 1, in which each of the pin holes in each said outer plate is circular and has an inner semi-circular side closest to the other pin hole in the same plate, and in which the groove in each said outer plate extends from the inner semi-circular side of one of the pin holes therein to the inner semi-circular side of the other pin hole.

10. A chain according claim 1, in which each of the pin holes in each said outer plate is circular and has an inner semi-circular side closest to the other pin hole in the same plate, in which the groove in each said outer plate extends from the inner semi-circular side of one of the pin holes therein to the inner semi-circular side of the other pin hole, and in which the shape of each said groove is in the form of an arc.

11. A chain according claim 1, in which each of the pin holes in each said outer plate is circular and has an inner semi-circular side closest to the other pin hole in the same plate, in which the groove in each said outer plate extends from the inner semi-circular side of one of the pin holes therein to the inner semi-circular side of the other pin hole, and in which said groove is formed by pressing the link plate in which it is formed

12. A chain according claim 1, in which each of the pin holes in each said outer plate is circular and has an inner semi-circular side closest to the other pin hole in the same plate, in which each said outer link plate has plural elongated, curved, grooves formed in one of its faces, each of said grooves connecting one the pin holes formed therein to the other pin hole formed therein, and extending from the inner semi-circular side of one of the pin holes therein to the inner semi-circular side of the other pin hole.
